(19) United States
(12) Patent Application Publication
(10) Pub. No.: US 2012/0086909 A1
(43) Pub. Date: Apr. 12, 2012

(54) Arc Flash Protection Shield

(76) Inventor: Roy Paulson, Temecula, CA (US)

(21) Appl. No.: 13/269,436

(22) Filed: Oct. 7, 2011

Related U.S. Application Data
(60) Provisional application No. 61/391,025, filed on Oct. 7, 2010.

(51) Int. Cl. G02C 7/16

(52) U.S. Cl. 351/163

(57) ABSTRACT

An arc shielding lens formed of plastic and a plurality of additives such as saturation absorbing dye and reverse saturation absorbing dye having enhanced reaction times to protect a user from arc flash energy.

This application claims priority to U.S. Provisional Patent Application No. 61/391,025, filed on Oct. 7, 2010 and included herein in its entirety by this reference.

### BACKGROUND OF THE INVENTION

1. Field of the Invention

The invention herein relates generally to eye and face protective shields. More specifically it relates to protection against high energy electric arc flashes and preventing user energy from the high heat flux exposure and the very high temperatures they can generate.

2. Prior Art

Eye and face protection is essential when working around high voltage electrical equipment, arc welders, lasers, and other equipment capable of producing arc flashes or high energy light which can harm a human's eyes and skin. An arc flash is a fault or an electrical breakdown of the resistance of air that results in an electric arc. Such an arc flash, where there is sufficient voltage involved, such as an arc flash with 1000 amperes or more, can generate substantial damage, fire and severe injury to humans or animals proximate to the arc flash.

The massive energy released in an arc flash will concurrently vaporize some or all of the metal conductors involved causing a blasting of molten metal and generating an expanding plasma outward with extreme force. Such arc flashes can easily produce a severe explosion and resulting injuries therefrom, in addition to those caused by the radiation the flash generates. As such, an arc flash can cause destruction of the equipment involved, fires, and severe injuries not only to the workers but also to any nearby people.

In addition to the explosive blast of such a fault, destruction also arises from the intense radiation and heat produced by the arc. The metal plasma arc produces tremendous amounts of light energy in ranges from far infrared to ultraviolet. Surfaces of nearby people and objects naturally will absorb this energy and are instantly heated to vaporizing temperatures. The effects of this can be seen on adjacent walls and equipment—they are often ablated and eroded from the radiant effects. Radiant heat is also prevalent during these flashes which can further cause injury to anyone nearby.

Protection from arc flashes more than often comes from categorically rated personal protective equipment, depending on the energy per unit area incident on the equipment. The incident energy is dependent on the current, arcing time, and distance from the arc event, therefore making the correct rated equipment difficult to determine.

U.S. Pat. No. 3,382,183 to Donoian et. al. teaches a plastic optical filter related to the stabilization of infrared absorbing organic dyes in plastic substrates. A problem arises due to the degradation of the infrared dyes in sunlight and the fact that the Donoian device is simply an optical filter and not an arc shield. Most conventional art teaches the employment of optical filters which do not provided the protection to the user and their face and eyes which is required when radiation is emitted from such high energy arc flashes.

As such, there is a continual unmet need for an arc flash protective shield which provides optical clarity, and optical correct viewing, which will not impede the user's eyesight. Such a protection shield in addition to unimpeded viewing, will provide arc flash protection for a higher range of energy from high electrical currents, or other high energy light and radiant energy which can harm a user's eyes and face. Such a device should react to provide this protection in the extremely short time frame allowed by arc flashes. Finally, such a device should provide this protection at both close and far distance from the source of the flash.

### SUMMARY OF THE INVENTION

The device herein provides a solution to the above noted shortcomings in the prior art. The current invention incorporates a plastic substrate formed as a lens, or as a coating or film on applied to one or both side surfaces of a lens. The substrate is formed in a solid solution with the base plastic material such as the preferred propionate, and a mixture including a plurality of nanoparticles of additives and dyes as well as other ingredients as a percentage of the weight of the propionate. The resulting lens or substrate formed as a solid solution of the mixture of additives and propionate, is then employed as the lens itself, or adhered to a side surface of a lens configured for placement in front of the eyes of a user, to provide highly improved arc flash protection.

The formed substrate is capable of reacting, in the minimal time frames allowed by a close proximity arc flash to negate and absorb the energy which might contact the user's eyes or face, and, in this minuscule time frame, it is capable of absorbing extremely high energy outputs of such arc flashes to protect the user's eyes and face therefrom.

In different preferred modes the arc flash shield device herein, may be employed as or in combination with a lens, thereby imparting the disclosed energy negation characteristics herein to the safety lens worn by a user. Further, as a coating or lens, the device herein may be employed for goggle technology as well as for hooded or unhooded face shields, and other optical shielding lenses and the like.

The plastic substrate such as propionate, is capable of this fast reacting energy absorbing protection, if formed in combination with one or a combination of a group of ingredients which provide arc flash protection consisting of one or combination of energy protecting ingredients including, energy reflecting nanoparticles, energy absorbing nanoparticles, saturation absorbing (SA) dyes, reverse saturation absorbing (RSA) dyes, zinc stearate, UV stabilizers, heat stabilizers, mineral oil, and FR agents. Used in combination, the ingredients exceed any protection afforded singularly.

An example of SA dyes would be the combination of dyes as used to tint a sunglass lens in which protection in the visible light range is achieved. For application in arc flash protection herein, it is desirable for the dyes to be concentrated with protection in the infrared spectrum and combined with the other ingredients herein noted. RSA dyes change from a ground to excited state with in the cycle of an arc flash. This causes the protective shield containing the RSA dies in the solid solution forming the shield to darken and lighted 120 times per second.

Some preferred proportions by weight as a percentage of the total weight of the plastic material forming the lens or film such as propionate, are as follows:

SA dyes: 1114 Dye 0.0220% to 0.1101%, 6131 Dye 0.0044% to 0.1101%; RSA dyes: 9807 Dye 0.0002% to 0.0551%, SA-PBPC Dye 0.0002% to 0.0551%; Zinc stearate 0.0022% to 0.0661%; UV stabilizer 0.0022% to 0.0661%; Irgonox 0.0011% to 0.0220%; Lab6 nanoparticles 0.0001% to 0.0220%; TiO2 nanoparticle 0.0002% to 0.0551%; Mineral Oil 0.0110% to 0.1101%.

An object of the current invention is to provide an optically correct lens having nanoparticles fixed therein in a solid solution, as a means for imparting arc flash protection for the wearer.

It is another object of the device to use reflective nanoparticles and absorptive nanoparticles in the formed solid solution polymer lens or film, to reflect and absorb arc flash electromagnetic energy respectively or in a combination thereof.

It is yet another object of the device to use SA dyes in the polymer solution surrounding reflective nanoparticles and RSA dyes surrounding reflective nanoparticles absorb and reflect electromagnetic energy respectively or combination thereof.

It is still another object of the invention to use nanoparticles of particular sizes optimized for the application.

These together with other objects and advantages which become subsequently apparent reside in the details of the construction and operation of arc flash protective lens herein as more fully hereinafter described and claimed, reference being had to the accompanying drawings forming a part thereof, wherein like numerals refer to like parts throughout.

### BRIEF DESCRIPTION OF THE FIGURES

FIG. 1 is a depiction of the preferred embodiment of the arc shielding device incorporated into a face shield formed of propionate or other material suitable to form the substrate.

FIG. 2 shows the matrix of the ingredients of the device of FIG. 1 along line 2-2.

FIG. 3 shows another embodiment of the device depicted in a goggle type eye protection.

FIG. 4 shows yet another possible embodiment of the device.

FIG. 5 depicts formation of a lens using one or a plurality of layers of transparent thermoplastic or thermoset in a single or multilayer.

### DETAILED DESCRIPTION OF THE PREFERRED EMBODIMENTS OF THE INVENTION

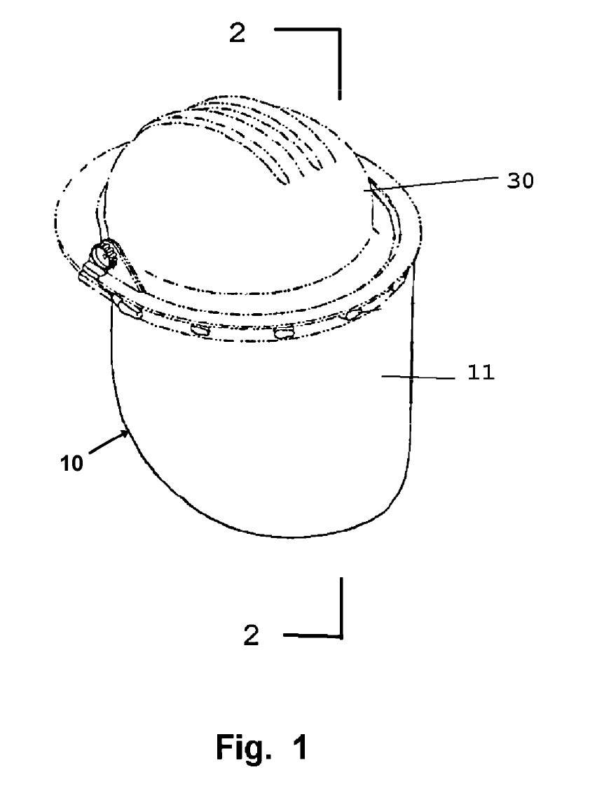

Now referring to drawings in FIGS. 1-4, wherein similar components are identified by like reference numerals, there is seen in FIG. 1 the lens or film arc shield protective device 10 as depicted in one preferred mode and containing the disclosed combination of materials formed in a solid solution of propionate and additives, yielding the lens or film thereon, and enabling the superior arc flash protection. The device 10 is shown as a lens or film plastic substrate 11, formed of a solid solution including a matrix of additive material in the transparent plastic substrate 11. The substrate may be formed of one or a combination of lens materials from conventional lens materials such as a group including, propionate which is preferred for optical qualities, or other conventional lens materials such as polycarbonate, Polymethylmethacrylate, Polyurethane, and engaged to a helmet 30. Propionate is especially preferred for optical correctness and clarity and compositions noted herein are based on use of this plastic. However those skilled in the art will realize other optical quality plastic may be employed and are considered within the scope herein.

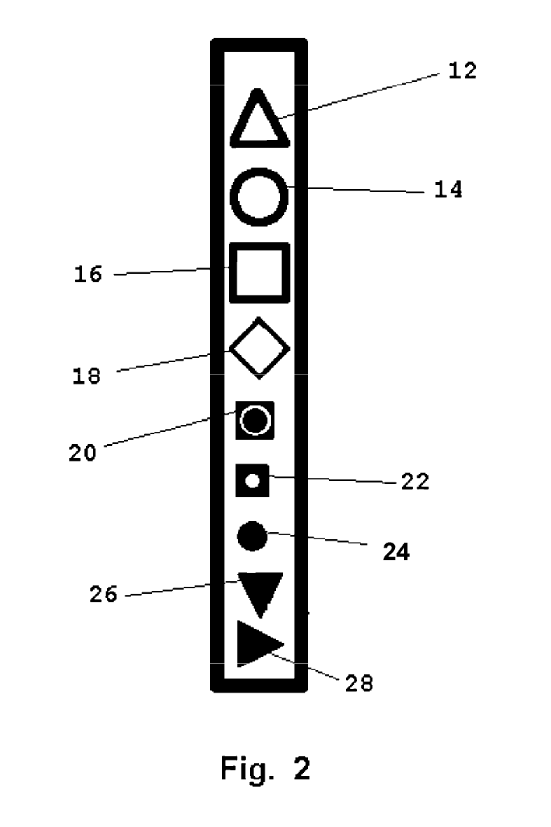

FIG. 2 depicts the matrix of materials which may be employed in combination for providing arc shielding capability within the solid solution forming transparent lens or film formed of the propionate plastic substrate 11.

Generally a preferred range of arc shielding materials contained in the substrate 11 herein of optical plastic, in proportion by weight of the shielding or additive ingredients in the formed substrate 11 to the weight of the optical plastic in the formed substrate 11 are as follows:
energy reflecting nanoparticles 12 at 0.0002 g to 0.0550%; energy absorbing nanoparticles 14 at 0.0023 to 0.0220%; saturation absorbing dyes (SA) 16 at 0.026 to 0.2200%; reverse absorbing dyes (RSA) 18 at 0.0004 to 0.1100%; zinc stearate 20 at 0.0020 to 0.0660%; UV stabilizer 22 at 0.0020 to 0.0260%; heat stabilizer 24 at 0.0010 to 0.0220%; mineral oil 26 at 0.0110 to 0.1100%; and FR agents 28 at 0.1 to 3%.

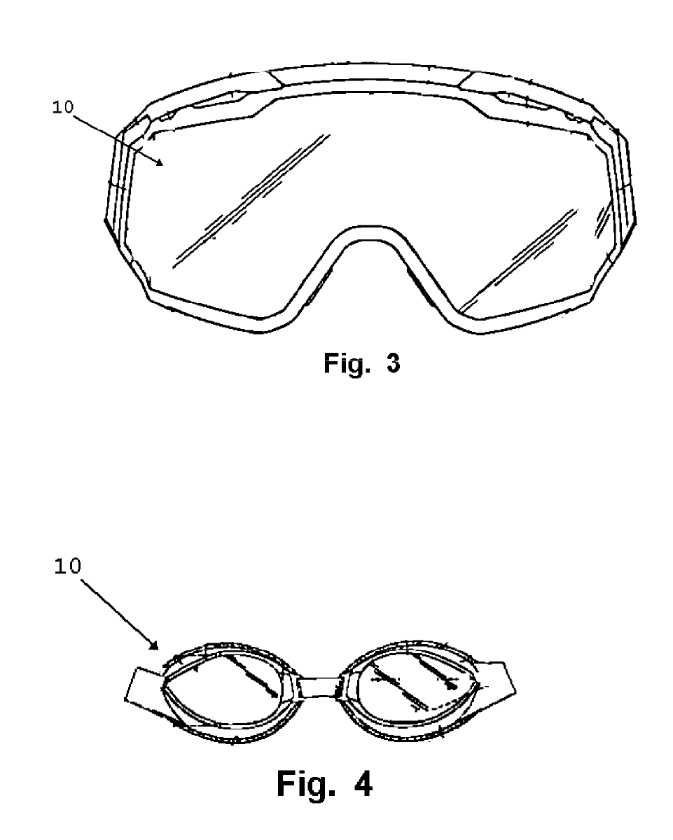

FIGS. 3 and 4 depict other modes for the lenses of employing the arc shielding capabilities of the disclosed device as needed for the level of protected desired.

In all modes of the formed shield device 10 one or a plurality of layers of the plastic substrate in film or lens form, containing one or a plurality of the preferred arc shielding materials, may be employed. Further, each layer may contain the same absorbing ingredients or ingredient, or each of the plurality of the layers may employ different organic absorbing ingredients. For protection against abrasion, and the like, the plastic substrate layers may be sandwiched between layers of glass.

The arc shielding ingredients noted herein, are dispersed through the solid solution forming the shield in a matrix so the energy and photon absorption and transfer to the phonons is in a substantially evenly dispersed, versus a concentrated, situation. The damage to the arc shield if the absorptive layer is too concentrated, versus dispersed, will increase as the energy calories are increased.

The following table depicts current preferred ranges of included additives in the matrix of additives included in the solid solution of optical plastic material and additives forming the arc shielding. The listed weights of the additives, are by weight of the additive material in proportion to total weight of the optical plastic, included with the individual additive in the formed lens or film shield. The optical plastic as noted, is propionate due to optical clarity, but can be other optical plastics or mixtures thereof. The SA total and the RSA total indicate a total one or a combination of the listed components.

| Material | Grams | Typical | | Min | | Max |
|---|---|---|---|---|---|---|
| Propionate | 45,400 | Percentage | Min | Percent | Max | Percent |
| 1114 Dye | 29.4 | 0.0648% | 10 | 0.0220% | 50 | 0.1101% |
| 6131 Dye | 5.8 | 0.0128% | 2 | 0.0044% | 50 | 0.1101% |
| SA Total | 35.2 | 0.0775% | 12 | 0.0264% | 100 | 0.2203% |
| 9807 Dye | 0.2 | 0.0004% | 0.1 | 0.0002% | 25 | 0.0551% |
| SA-PBPC Dye | 0.4 | 0.0009% | 0.1 | 0.0002% | 25 | 0.0551% |
| RSA Total | 0.6 | 0.0013% | 0.2 | 0.0004% | 50 | 0.1101% |
| Zinc Stearate | 20 | 0.0441% | 1 | 0.0022% | 30 | 0.0661% |
| UV Stabilizer | 8 | 0.0176% | 1 | 0.0022% | 12 | 0.0264% |
| Irgonox | 2 | 0.0044% | 0.5 | 0.0011% | 10 | 0.0220% |
| Lab6 | 0.1 | 0.0002% | 0.05 | 0.0001% | 10 | 0.0220% |
| Nanoparticles | | | | | | |
| Tio2 | 0.4 | 0.0009% | 0.1 | 0.0002% | 25 | 0.0551% |
| nanoparticles | | | | | | |
| Minerial Oil | 25 | 0.0551% | 5 | 0.0110% | 50 | 0.1101% |

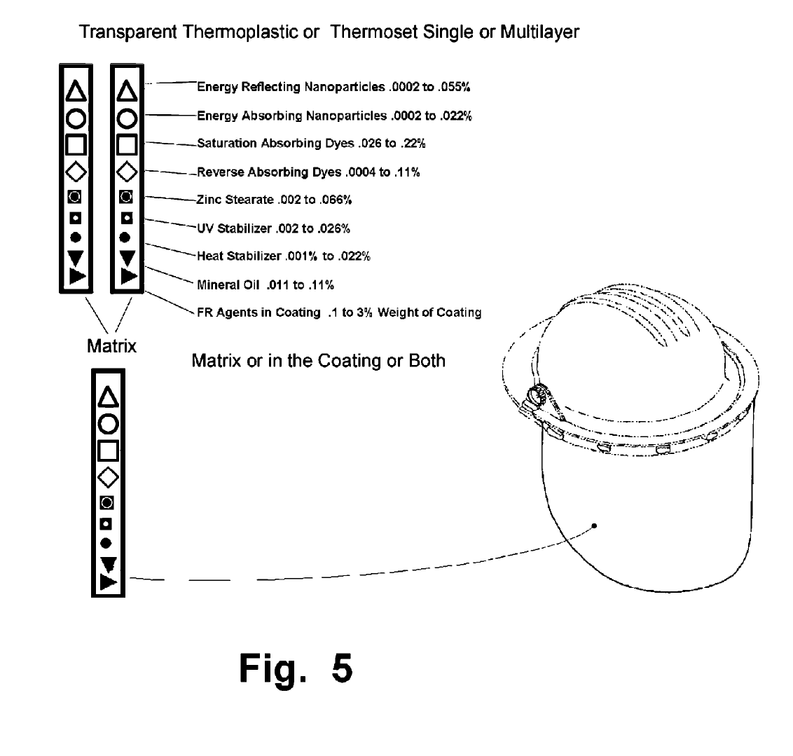

FIG. 5 depicts formation of the formed lens or film substrate 11, providing the protective lens to a user, and employing the above reference materials in one or a plurality of layers of transparent thermoplastic or thermoset in a single or multilayer.

While all of the fundamental characteristics and features of the arc shielding lens and system herein have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. An arc shielding lens comprising:
a solid solution formed of a mixture of optical plastic and a combination of additives by weight;
said additives included by percentage of the total weight of said optical plastic mixed therewith, in the following amounts;
saturation absorbing dye 0.0264% to 0.2203%;
reverse saturation absorbing dye 0.0004% to 0.1101%;
Zinc Stearate 0.0022% to 0.0661%;
UV Stabilizer 0.0022% to 0.0264%;
Irgonox 0.0011% to 0.0220%;
Lab6 nanoparticles 0.0001% to 0.0220%;
Tio2 nanoparticles 0.0002% to 0.0551%; and
Mineral Oil 0.0110% to 0.1101%.

2. The arc shielding lens of claim 1, additionally comprising:
said saturation absorbing dye is one or a combination of saturation absorbing dyes from a group including 1114 Dye and 6131 Dye.

3. The arc shielding lens of claim 1, additionally comprising:
said reverse saturation absorbing dye is one or a combination of reverse saturation absorbing dyes from a group including 9807 Dye and SA-PBPC Dye.

4. The arc shielding lens of claim 2, additionally comprising:
said reverse saturation absorbing dye is one or a combination of reverse saturation absorbing dyes from a group including 9807 Dye and SA-PBPC Dye.

5. The arc shielding lens of claim 1, additionally comprising:
said optical plastic comprising propionate.

6. The arc shielding lens of claim 2, additionally comprising:
said optical plastic comprising propionate.

7. The arc shielding lens of claim 3, additionally comprising:
said optical plastic comprising propionate.

8. The arc shielding lens of claim 4, additionally comprising:
said optical plastic comprising propionate.
